(19) United States
(12) Patent Application Publication
(10) Pub. No.: US 2023/0075369 A1
(43) Pub. Date: Mar. 9, 2023

(54) PSEUDO-LABEL GENERATION USING AN ENSEMBLE MODEL

(71) Applicant: SAP SE, Walldorf (DE)

(72) Inventors: Sohyeong KIM, Berlin (DE); Christian REISSWIG, Berlin (DE)

(21) Appl. No.: 17/469,075

(22) Filed: Sep. 8, 2021

(51) Int. Cl. G06N 20/20; G06K 9/62

(52) U.S. Cl. CPC G06N 20/20; G06K 9/6256

(57) ABSTRACT

Systems and methods include training of each of a plurality of models based on a first set of training data comprising a first plurality of pairs, each of the first plurality of pairs comprising a feature and a corresponding label, inputting of each of a plurality of features into each of the plurality of trained models to generate, for each feature of the plurality of features, a plurality of output labels, determining, for each of the plurality of features, a pseudo-label based on the plurality of output labels generated for the feature, determining a second set of training data comprising a second plurality of pairs, each of the second plurality of pairs comprising one of the plurality of features and a pseudo-label determined for the one of the plurality of features, and training an inference model to output an inferred label based on the first set of training data and the second set of training data.

### BACKGROUND

Modern database systems store vast amounts of data for their respective enterprises. Applications and other logic may access this stored data in order to perform various functions. Functions may include estimation or forecasting of data values based on stored data. Such estimation or forecasting is increasingly provided by trained neural networks, or models.

A model may be trained to infer a value of a target based on a set of input data. The training may utilize historical data consisting of sets of input data and a target value corresponding to each set of input data. The sets of input data may be referred to as features and the target values may be referred to as labels. The training data therefore consists of many feature, label pairs. In one example, each feature of a pair consists of specific fields of a sales order and each label of a pair includes a respective delivery date corresponding to the sales order. A model which is trained based on these pairs may infer a label (i.e., a delivery date) from an input feature (i.e., the specific fields of a sales order).

The usefulness of a trained model is influenced by the volume of data used to train the model. The patterns learned by a model which is trained using limited training data are overfit to the training data, resulting in an inability of the model to accurately infer labels from input features which differ from the training data. However, obtaining a sufficient volume of training data may be difficult.

Features, no matter how plentiful, may be used as training data only if they are associated with corresponding labels. For example, images used to train a network to output a label must each be associated with a label. Such data labelling often consumes significant time and resources, resulting in undesirable trade-offs between the cost of model training and the usefulness of the trained model. Systems to facilitate the generation of training data labels are desired.

### BRIEF DESCRIPTION OF THE DRAWINGS

FIG. 1A illustrates training a plurality of models based on a labeled dataset according to some embodiments.

FIG. 1B illustrates generating a pseudo-labeled dataset based on input features using a plurality of trained models according to some embodiments.

FIG. 1C illustrates training a model based on a labeled dataset and a pseudo-labeled dataset according to some embodiments.

FIG. 2 is a flow diagram of a process to generate a pseudo-labeled dataset and train a model based on a labeled dataset and the pseudo-labeled dataset according to some embodiments.

FIG. 3 illustrates training a plurality of models based on a labeled dataset according to some embodiments.

FIG. 4 illustrates generating pseudo-labels corresponding to input features using a plurality of trained models according to some embodiments.

FIG. 5 illustrates training a model based on a labeled dataset and a pseudo-labeled dataset according to some embodiments.

FIG. 6 illustrates knowledge distillation according to some embodiments.

FIG. 7 is a block diagram of a system using a machine learning service for training a model based on a labeled dataset and a pseudo-labeled dataset according to some embodiments.

FIG. 8 is a block diagram of a hardware system training a model based on a labeled dataset and a pseudo-labeled dataset according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments operate to train multiple models based on a set of labeled training data, to generate pseudo-labels corresponding to each of a plurality of features using the trained models, and to train a model based on the labeled training data and on pseudo-labeled training data comprised of the plurality of features and corresponding pseudo labels. The quality of the generated pseudo-labels may be improved over prior systems due to regularization provided by the multiple trained models, resulting in improved the accuracy of the final trained model. Further, using the final trained model for subsequent inferences requires less time and fewer resources than use of the multiple trained models.

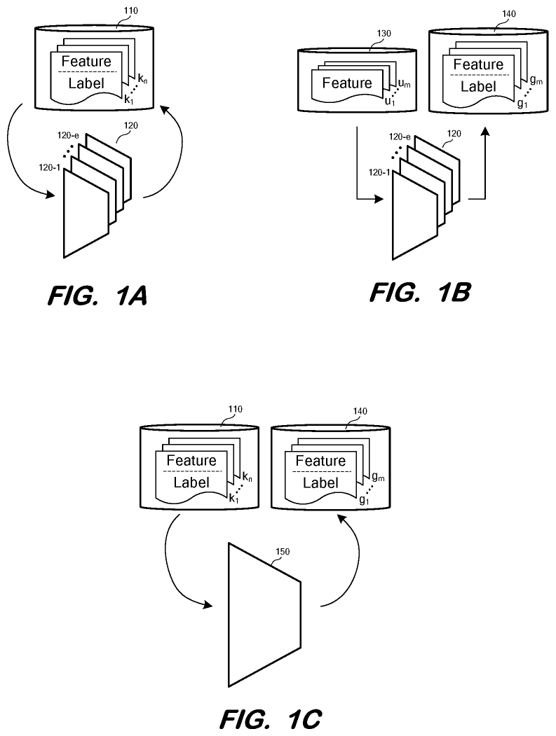

FIGS. 1A through 1C illustrate operation according to some embodiments. Each element of FIGS. 1A through 1C, as well each other element described herein, may be implemented using any suitable combination of co-located or distant computing hardware and/or software that is or becomes known. Such combinations may include implementations which apportion computing resources elastically according to demand, need, price, and/or any other metric. In this regard, one or more elements may be implemented as a cloud service (e.g., Software-as-a-Service, Platform-as-a-Service). Two or more described elements are implemented by a single computing device.

FIG. 1A illustrates training of a plurality of models 120 based on a labeled dataset 110 according to some embodiments. Labeled dataset (D_{L}) 110 includes N feature, label pairsₖ₁₋ₖₙ such that D_{L}={(x, y)}. If y is a real number (i.e., y∈R), then models 120 are being trained to perform a regression task. If y consists of an integer (i.e., y∈{0, 1, . . . n}) or tuples thereof, then models 120 are being trained to perform a classification or multi-classification task. A classification task outputs a probability associated with each of two or more classes of a single type (e.g., Yes or No), while a multi-classification task outputs a probability associated with each of two or more classes of two or more types (e.g., dog or cat, male or female).

Each of models 120, and all other models described herein, may comprise a network of neurons which receive input, change internal state according to that input, and produce output depending on the input and internal state. The output of certain neurons is connected to the input of other neurons to form a directed and weighted graph. The weights as well as the functions that compute the internal state can be modified by a training process based on ground truth data. Models as described herein may comprise any one or more types of artificial neural network model that are or become known, including but not limited to convolutional neural network models, recurrent neural network models, long short-term memory network models, deep reservoir computing and deep echo state network models, deep belief network models, and deep stacking network models.

Each of models 120 is designed as is known in the art to perform the task associated with the labels of dataset 110. Each of models 120 differs from each other of models 120 in terms of their hyperparameters, their training, or both. For example, a structure of model 120-1, which is conforms to hyperparameters defining model 120-1, may differ from one or more of other models 120. If, for example, the structure (i.e., hyperparameters) of model 120-1 were identical to the structure of another of models 120, then model 120-1 would be trained differently from the other model 120. Different training may consist of different initialization, a different number of training steps, different loss functions, different gradient descent implementations, and/or any other differences. Generally, each of models 120 implements a different function ƒᵢ(x)=yᵢ after training is complete.

FIG. 1B illustrates generation of pseudo-labeled dataset (D_{P}) 140 based on input unlabeled dataset (D_{U}) 130 using models 120 trained as shown in FIG. 1A according to some embodiments. Unlabeled dataset 130 consists of M features u₁₋ᵤₘ such that D_{U}={(x)}. Generally, for each of features ᵤ₁₋ᵤₘ, each of trained models 120 infers a pseudo-label yᵢ′ and a pseudo-label y′ is generated based on all the inferred pseudo-labels yᵢ′. Each feature is then associated with its corresponding pseudo-label y′ within a feature, label pair of pseudo-labeled dataset 140 such that D_{P}={(x, y′)}.

FIG. 1C illustrates training of model 150 based on labeled dataset 110 and pseudo-labeled dataset 140 according to some embodiments. Model 150 may be trained using minibatches as is known in the art, and each minibatch may comprise feature, label pairs from labeled dataset 110 and from pseudo-labeled dataset 140. In some embodiments, each minibatch includes using a fixed ratio of pairs from each dataset.

Model 150 may conform to the same hyperparameters as any of models 120. In some embodiments, model 150 includes a greater number of free parameters than some or all of models 120. If trained using a small number of training samples, models which include a large number of free parameters (i.e., high-capacity models) will tend to overfit to training samples and not generalize well over different data sets. However, using the relatively larger number of training samples provided by some embodiments, a greater number of free parameters allows model 150 to better generalize over different data sets than a smaller model.

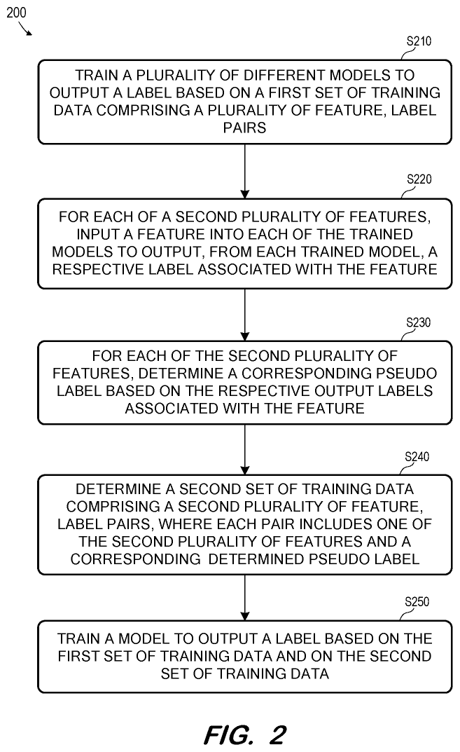

FIG. 2 is a flow diagram of a process to generate a pseudo-labeled dataset and train a model based on a labeled dataset and the pseudo-labeled dataset according to some embodiments. Process 200 and all other processes mentioned herein may be embodied in processor-executable program code read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S210, a plurality of different models are trained to output a label based on a first set of training data comprising a plurality of feature, label pairs. Such training may proceed as is known in the art. As described with respect to FIG. 1A, each of the plurality of models may differ from each other model in structure and/or in the manner in which the model is trained at S210.

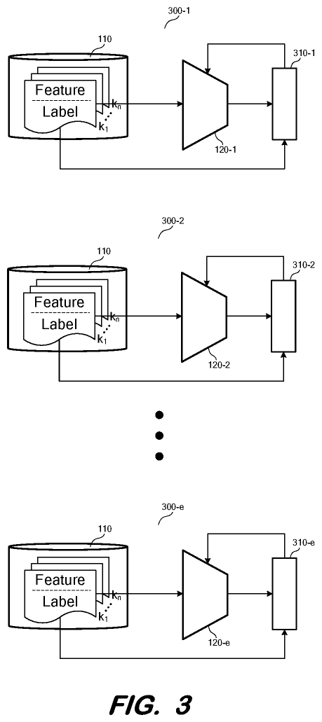

FIG. 3 includes representations of training architectures 300-1, 300-2 and 300-e according to some embodiments. Each of training architectures 300-1, 300-2 and 300-e may be used to train a respective one of models 120-1, 120-2 and 120-e at S210 based on labeled dataset 110. Labeled dataset 110, as described above, includes N feature, label pairsₖ₁₋ₖₙ.

In one example of training using training architecture 300-1, a minibatch (i.e., a subset) of feature, label pairsₖ₁₋ₖₙ is determined and the features of each pair of the minibatch are input to model 120-1. Model 120-1 generates a label corresponding to each input feature and the labels are received by loss layer 310-1. Loss layer 310-1 determines a total loss based on a difference between each label generated by model 120-1 and the actual label associated with the input feature from which the label was generated. The total loss is back-propagated to model 120-1 in order to modify parameters of model 120-1 (e.g., using known stochastic gradient descent algorithms) in an attempt to minimize the total loss. Model 120-1 is iteratively modified in this manner, using a new minibatch at each iteration, until the total loss reaches acceptable levels or training otherwise terminates (e.g., due to time constraints or to the loss asymptotically approaching a lower bound). At this point, network model 120-1 is considered trained.

Training architectures 300-2 and 300-e may operate as described above. In addition to potential differences in the structure of models 120-1, 120-2 and 120-e, the training thereof implemented by training architectures 300-1, 300-2 and 300-e may also differ, for example by using different initialization, a different number of training steps, different loss functions, different gradient descent implementations, and/or any other differences.

Although training architectures 300-1, 300-2 and 300-e are shown as independent for explanatory purposes, one or more training architectures may include common elements. For example, all training architectures 300-1, 300-2 and 300-e may access a same storage device storing a same copy of dataset 110, and/or one or more of training architectures 300-1, 300-2 and 300-e may utilize a same loss layer which performs dedicated operations for each of the one or more training architectures. Other optimizations will be known to those in the art.

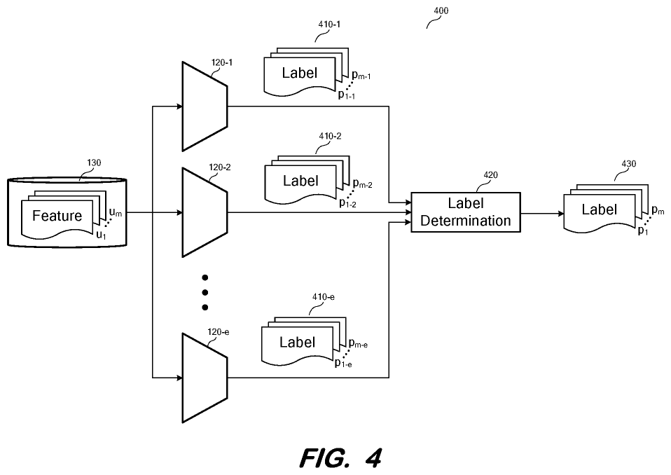

Returning to process 200, S220 and S230 are performed to determine pseudo-labels for each of a second plurality of unlabeled features. FIG. 4 illustrates system 400 to perform S220 and S230 according to some embodiments.

At S220, each unlabeled feature is input into each of the trained models to output, from each trained model, a respective label associated with each feature. Referring to FIG. 4, unlabeled dataset 130 consists of M features ᵤ₁₋ᵤₘ. At S220 in the present example, each of features ᵤ₁₋ᵤₘ is input into trained models 120-1, 120-2 and 120-e. As a result, trained model 120-1 outputs corresponding pseudo-labelsₚ₁₋₁₋ₚₘ₋₁, trained model 120-2 outputs corresponding pseudo-labelsₚ₁₋₂₋ₚₘ₋₂, and trained model 120-e outputs corresponding pseudo-labelsₚ₁₋ₑ₋ₚₘ₋ₑ.

A pseudo-label corresponding to each feature is determined at S230 based on the respective pseudo-labels output by each model based on the feature. According to system 400, label determination component 420 receives all labels output by each of the plurality of trained models, and generates pseudo-labels 430 for each of features ᵤ₁₋ᵤₘ based thereon. For z=i to m, label determination component 420 determines pseudo-label_{pz} corresponding to feature_{uz} based on each pseudo-label which was output by trained models 120-1, 120-2 and 120-e based on feature_{uz} (i.e., pseudo-label_{pz-1}, pseudo-label_{pz-2}, and pseudo-label_{pz-e}). Pseudo-label_{pz1} may be determined based on pseudo-label_{pz-1}, pseudo-label_{pz-2}, and pseudo-label_{pz-e} in any suitable manner, including but not limited to majority voting (i.e., choosing the most-often occurring value of the pseudo-labels) or averaging the softmax outputs of each trained model.

In the case of classification models, majority voting for pseudo-label y′ at S230 may be represented as follows, where I=1 if ƒᵢ(x)=c is true and 0 otherwise:

$${y}^{′} = arg {max}_{c} {\sum }_{i}^{N} I ( {f}_{i} ( x ) = c )$$

Also for classification models, S230 may comprise averaging confidence values associated with each candidate classification across the model outputs and choosing the classification associated with the highest average. Using conƒᵢ^{c}(x) as the confidence value of model ƒᵢ(x), class c:

$${y}^{′} = arg {max}_{c} [ {\sum }_{i}^{N} {conf}_{i}^{c} ( x ) ] / N$$

In the case of regression models, the determination at S230 may be represented as an average of all pseudo-labels output by the trained models:

$${y}^{′} = [ {\sum }_{i}^{N} {f}_{i} ( x ) ] / N$$

Next, a second set of training data is determined at S240. The second set of training data comprises a second plurality of feature, label pairs, where each pair includes one of the second plurality of features and a corresponding pseudo-label determined at S230. Continuing the above example, each feature is paired with its corresponding pseudo-label_{pz} to generate pair_{gz} of pseudo-labeled dataset 140.

A model is trained at S250 to output a label based on the first set of training data and on the second set of training data. The model may conform to the same or different hyperparameters as any of the models trained at S210. The model may also be trained using the same or different training parameters as used in S210.

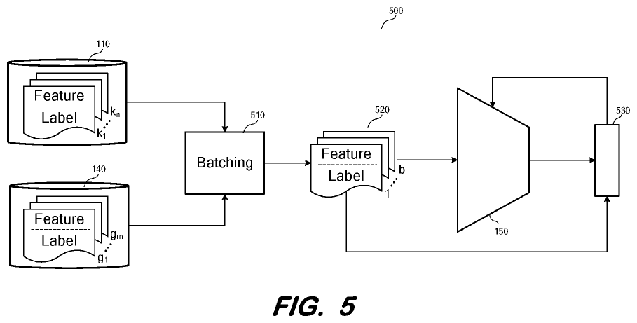

FIG. 5 illustrates training of model 150 at S250 based on labeled dataset 110 and pseudo-labeled dataset 140 according to some embodiments. Batching component 510 generates minibatch 520 of pairs_{1-b} based on pairsₖ₁₋ₖₙ of labeled dataset 110 and on pairs_{g1-gn} of pseudo-labeled dataset 140. Batching component 510 may, for example, generate minibatch 520 to include four times as many pairs from pairsₖ₁₋ₖₙ as from pairs_{g1-gn} (i.e., an 80/20) ratio. Such a ratio allows training of model 150 to be dominated by the higher-quality labels of pairsₖ₁₋ₖₙ. Embodiments are not limited to an 80/20 ratio, to a fixed ratio, or to minibatches which always include more pairs from pairsₖ₁₋ₖₙ than from pairs_{g1-gn}.

The features of each of pairs_{1-b} are input to model 150, which outputs B corresponding labels in response. Loss layer 530 determines a total loss based on a difference between labels output from model 150 and corresponding labels of pairs_{1-b} of minibatch 520, and model 150 is modified based on the total loss. Batching component 510 then determines a new minibatch 520 as described above and the process continues until training is deemed to be complete or otherwise terminated.

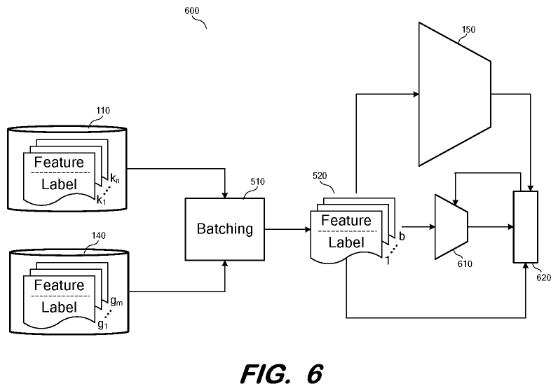

By increasing the number of available training samples, embodiments may facilitate training of a large capacity model which generalizes well. It may be desirable, for speed and/or computational resource concerns, to achieve substantially similar performance from a smaller capacity model. FIG. 6 illustrates system 600 for training smaller capacity model 610 to approximate the internal representation of trained higher capacity model 150 according to some embodiments.

Batching component 510 may operate as described above with respect to FIG. 5 to generate minibatches 520 based on labeled dataset 110 and pseudo-labeled dataset 140. The features of minibatches 520 are input to model 150 and to model 610, each of which outputs a corresponding set of labels to loss layer 620. As is known in the art, loss layer 620 determines a loss based on a difference between labels output from model 610 and corresponding labels of pairs_{1-b} of minibatch 520 and on the labels output from model 150. Model 610 is modified based on this total loss, with the dual goals of both minimizing the difference between labels output from model 610 and corresponding labels of pairs_{1-b} of minibatch 520 and mimicking the operation of model 150.

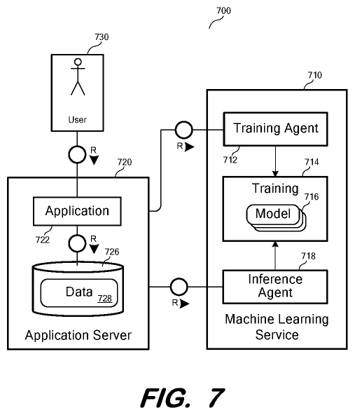

FIG. 7 is a block diagram of system 700 according to some embodiments. Generally, machine learning service 710 may operate as described herein to generate a pseudo-labeled dataset based on a labeled dataset and to train a model based on the labeled dataset and the pseudo-labeled dataset. Machine learning service 710 may comprise a cloud-based service accessible by various applications.

Training agent 712 may receive labeled training data and instruct training component 714 to train a plurality of models 716 based on the labeled training data as described herein. Training agent 712 may also receive unlabeled features and utilize the trained models 716 to generate pseudo-labels for the unlabeled features. Finally, as also described herein, training agent 712 may instruct training component 714 to train a final model based on the labeled dataset and the pseudo-labeled dataset. Inference agent 718 may receive features and input the features to the trained final model to generate associated labels.

Application server 720 may comprise an on-premise or cloud-based server providing an execution platform and services to applications such as application 722. Application 722 may comprise program code executable by a processing unit to provide functions to users such as user 730 based on data 728 stored in data store 726. Data store 726 may comprise any suitable storage system such as a database system, which may be partially or fully remote from application server 720, and may be distributed as is known in the art.

During operation, application 722 may transmit a request to training agent 712 for generation of a model based on labeled data and on unlabeled features. The request may include a labeled dataset and unlabeled features acquired from data 728. Once a final model is trained as described herein, application 722 may transmit a request to inference agent 718 to infer a label based on features stored in data 728 using the final model.

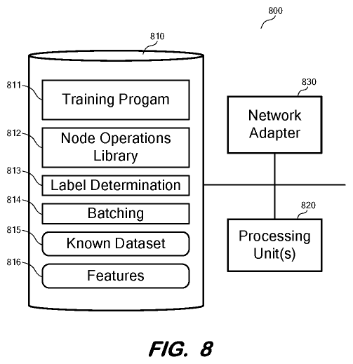

FIG. 8 is a block diagram of a hardware system providing model training according to some embodiments. Hardware system 800 may comprise a general-purpose computing apparatus and may execute program code to perform any of the functions described herein. Hardware system 800 may be implemented by a distributed cloud-based server (e.g., a virtual machine) and may comprise an implementation of machine learning service 710 in some embodiments. Hardware system 800 may include other unshown elements according to some embodiments.

Hardware system 800 includes processing unit(s) 820 operatively coupled to data storage device 810, and to network adapter 830. Data storage device 810 may comprise any appropriate persistent storage device, including combinations of magnetic storage devices (e.g., magnetic tape, hard disk drives and flash memory), optical storage devices, Read Only Memory (ROM) devices, and RAM devices.

Data storage device 810 stores program code executed by processing unit(s) 820 to cause system 800 to implement any of the components and execute any one or more of the processes described herein. Embodiments are not limited to execution of these processes by a single computing device. Such program code includes training program 811 to execute training of models based on datasets as described herein. Training may be configured and initiated by a user via interaction with interfaces exposed by training program 811, for example over the Web. Such configuration may include definition of model hyperparameters, training datasets, loss functions, etc. Node operations library 812 may include program code to execute operations within a model during training.

As described herein, label determination 813 may be executed to determine a label based on a plurality of labels, and batching 814 may be controlled by training program to generate minibatches based on a labeled dataset and a pseudo-labeled dataset. Known dataset 815 and features 816 may be used to generate a pseudo-labeled dataset as also described herein. Data storage device 810 may also store data and other program code for providing additional functionality and/or which are necessary for operation of hardware system 800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code; and
a processing unit to execute the processor-executable program code to cause the system to:
train each of a plurality of models based on a first set of training data comprising a first plurality of pairs, each of the first plurality of pairs comprising a feature and a corresponding label;
input each of a plurality of features into each of the plurality of trained models to generate, for each feature of the plurality of features, a plurality of output labels;
determine, for each of the plurality of features, a pseudo-label based on the plurality of output labels generated for the feature;
determine a second set of training data comprising a second plurality of pairs, each of the second plurality of pairs comprising one of the plurality of features and a pseudo-label determined for the one of the plurality of features; and
train an inference model to output an inferred label based on the first set of training data and the second set of training data.

2. A system according to claim 1, wherein each of the plurality of models conforms to hyperparameters which are different from hyperparameters to which each other of the plurality of models conforms, and/or is trained using training parameters different from the training parameters used to train each other of the plurality of models.

3. A system according to claim 2, wherein the inference model conforms to hyperparameters which are different from hyperparameters to which each of the plurality of models conforms.

4. A system according to claim 1, wherein determination of a pseudo-label for a feature comprises determining an average of the plurality of output labels generated for the feature.

5. A system according to claim 1, wherein determination of a pseudo-label for a feature comprises determining a most-often occurring value of the plurality of output labels generated for the feature.

6. A system according to claim 1, wherein training of the inference model to output an inferred label based on the first set of training data and the second set of training data comprises determining minibatches comprising a fixed ratio of pairs from the first set of training data and pairs from the second set of training data.

7. A system according to claim 6, the processing unit to execute the processor-executable program code to cause the system to:
train a second inference model based on the first set of training data, the second set of training data and the inference model,
wherein training of the second inference model comprises inputting minibatches comprising a fixed ratio of pairs from the first set of training data and pairs from the second set of training data to the inference model and to the second inference model, and
wherein the second inference model includes fewer free parameters than the inference model.

8. A method comprising:
training each of a plurality of models based on a first set of training data comprising a first plurality of pairs, each of the first plurality of pairs comprising a feature and a corresponding label;
inputting each of a plurality of features into each of the plurality of trained models to generate, for each feature of the plurality of features, a plurality of output labels;
determining, for each of the plurality of features, a pseudo-label based on the plurality of output labels generated for the feature;
determining a second set of training data comprising a second plurality of pairs, each of the second plurality of pairs comprising one of the plurality of features and a pseudo-label determined for the one of the plurality of features; and
training an inference model to output an inferred label based on the first set of training data and the second set of training data.

9. A method according to claim 8, wherein each of the plurality of models conforms to hyperparameters which are different from hyperparameters to which each other of the plurality of models conforms, and/or is trained using training parameters different from the training parameters used to train each other of the plurality of models.

10. A method according to claim 9, wherein the inference model conforms to hyperparameters which are different from hyperparameters to which each of the plurality of models conforms.

11. A method according to claim 8, wherein determining a pseudo-label for a feature comprises determining an average of the plurality of output labels generated for the feature.

12. A method according to claim 8, wherein determining a pseudo-label for a feature comprises determining a most-often occurring value of the plurality of output labels generated for the feature.

13. A method according to claim 8, wherein training the inference model to output an inferred label based on the first set of training data and the second set of training data comprises determining minibatches comprising a fixed ratio of pairs from the first set of training data and pairs from the second set of training data.

14. A method according to claim 13, further comprising:
training a second inference model based on the first set of training data, the second set of training data and the inference model,
wherein training the second inference model comprises inputting minibatches comprising a fixed ratio of pairs from the first set of training data and pairs from the second set of training data to the inference model and to the second inference model, and
wherein the second inference model includes fewer free parameters than the inference model.

15. A non-transitory medium storing processor-executable program code executable by a processing unit of a computing system to cause the computing system to:
train each of a plurality of models based on a first set of training data comprising a first plurality of pairs, each of the first plurality of pairs comprising a feature and a corresponding label;
input each of a plurality of features into each of the plurality of trained models to generate, for each feature of the plurality of features, a plurality of output labels;
determine, for each of the plurality of features, a pseudo-label based on the plurality of output labels generated for the feature;
determine a second set of training data comprising a second plurality of pairs, each of the second plurality of pairs comprising one of the plurality of features and a pseudo-label determined for the one of the plurality of features; and
train an inference model to output an inferred label based on the first set of training data and the second set of training data.

16. A medium according to claim 15, wherein each of the plurality of models conforms to hyperparameters which are different from hyperparameters to which each other of the plurality of models conforms, and/or is trained using training parameters different from the training parameters used to train each other of the plurality of models.

17. A medium according to claim 15, wherein determination of a pseudo-label for a feature comprises determining an average of the plurality of output labels generated for the feature.

18. A medium according to claim 15, wherein determination of a pseudo-label for a feature comprises determining a most-often occurring value of the plurality of output labels generated for the feature.

19. A medium according to claim 15, wherein training of the inference model to output an inferred label based on the first set of training data and the second set of training data comprises determining minibatches comprising a fixed ratio of pairs from the first set of training data and pairs from the second set of training data.

20. A medium according to claim 19, the processor-executable program code executable by a processing unit of a computing system to cause the computing system to:
train a second inference model based on the first set of training data, the second set of training data and the inference model,
wherein training of the second inference model comprises inputting minibatches comprising a fixed ratio of pairs from the first set of training data and pairs from the second set of training data to the inference model and to the second inference model, and
wherein the second inference model includes fewer free parameters than the inference model.
